(19) United States
(12) Patent Application Publication
(10) Pub. No.: US 2025/0241484 A1
(43) Pub. Date: Jul. 31, 2025

(54) COOKING APPLIANCE

(71) Applicant: StoreBound LLC, New York, NY (US)

(72) Inventor: Fang LEI, Cixi Ningbo (CN)

(73) Assignee: StoreBound LLC, New York, NY (US)

(21) Appl. No.: 18/591,652

(22) Filed: Feb. 29, 2024

Related U.S. Application Data
(60) Provisional application No. 63/627,288, filed on Jan. 31, 2024.

(51) Int. Cl. A47J 37/06; A47J 36/34

(52) U.S. Cl. CPC A47J 37/0611; A47J 36/34

(57) ABSTRACT

A double-layer rotary cooking appliance with a storable base, which has a base and a cooking appliance main body erected on the base; the cooking appliance main body is rotatably connected to the base; the base has at least two supporting legs capable of rotating oppositely, and the supporting legs are connected through a locking mechanism, so that the base is in an unfolding state and a storage state; in the unfolding state, the supporting legs are positioned below the cooking appliance main body, so that the cooking appliance main body is positioned at a higher position relative to the placement plane; in the storage state, the supporting legs are positioned at two sides of the cooking appliance main body, so that the cooking appliance main body is positioned at a lower position relative to the placement plane.

### CROSS-REFERENCE TO RELATED APPLICATIONS

The present application claims the benefit of U.S. Provisional Application Ser. No. 63/627,288, filed Jan. 31, 2024, the entirety of which is incorporated herein by reference.

### BACKGROUND OF THE INVENTION

The cooking appliance is intended to cook food items such as pancakes, waffles, and the like. The rotary cooking appliance provides a convenient cooking mode for users. When a user uses the rotary cooking appliance, the user can rotate the cooking appliance body to enable cooking on two different cooking surfaces. This achieves even heating of the food item and allows two items to be cooked simultaneously.

In order to enable the cooking appliance to smoothly rotate and not interfere with the placing tabletop in the rotating process, a base is usually arranged on the cooking appliance, the base is lifted, and the cooking appliance is rotated on the base. However, the arrangement of the base increases the occupied space of the cooking appliance, thereby causing inconvenience in storage and transportation.

### SUMMARY OF THE INVENTION

In order to solve the problems in the prior art, the present disclosure provides a double-layer rotary cooking appliance with a storable base.

In some implementations, the invention may be a cooking appliance having a main body and a base, the main body having a heating element and a cooking surface. The base is rotatably coupled to the main body. The base has a locking mechanism and first and second supporting legs coupled to the locking mechanism. The first and second supporting legs each have a supporting foot. The base has an unfolded state and a storage state. In the unfolded state the supporting feet of the first and second supporting legs are positioned below the cooking appliance main body. In the storage state, the first and second supporting legs are positioned on opposite sides of the main body.

In another implementation, the invention may be a cooking appliance having a main body and a base, the main body having a heating element and a cooking surface. The base is coupled to the main body. The base has a locking mechanism having a locking piece and first and second locking blocks. The first and second locking blocks are configured to rotate about first and second axes. The base further has first and second supporting legs coupled to the first and second locking blocks of the locking mechanism. The base has an unfolded state and a storage state. The first and second supporting legs rotating about the first and second axes when the base is transitioned from the unfolded state to the storage state.

In yet another implementations, the invention may be a cooking appliance having a main body and a base, the main body having a first cooking surface and a second cooking surface. The base is coupled to the main body. The base has a locking mechanism and first and second supporting legs coupled to the locking mechanism. The first and second supporting legs are configured to rotate about first and second axes. The base has an unfolded state and a storage state. The first and second supporting legs rotate about the first and second axes when the base is transitioned from the unfolded state to the storage state. In addition, the main body has a first orientation with respect to the base and a second orientation opposite the first orientation.

Further areas of applicability of the present technology will become apparent from the detailed description provided hereinafter. It should be understood that the detailed description and specific examples, while indicating the preferred implementation, are intended for purposes of illustration only and are not intended to limit the scope of the technology.

### BRIEF DESCRIPTION OF THE DRAWINGS

FIG. 1 is a schematic exploded view of a cooking appliance in accordance with an embodiment of the present invention.

FIG. 2 is a perspective view of the cooking appliance showing a cooking surface.

FIG. 3 is another exploded view of the cooking appliance showing a cooking surface and a heating element.

FIG. 4 is an exploded view of a base of the cooking appliance of FIG. 1.

FIG. 5 is a schematic view of the base between an unfolded state and a storage state.

FIG. 6 is a schematic structural view of the base is in the storage state.

FIG. 7 is a schematic structural view of the base in the unfolded state.

FIG. 8 is a perspective view illustrating rotation of the main body.

FIG. 9 is a schematic view of a transmission piece.

FIG. 10 is a schematic view of the cooking appliance in the storage state.

FIG. 11 is a schematic view of the cooking appliance in the unfolded state.

FIG. 12 is a schematic view showing a placement structure for a food tray.

All drawings are schematic and not necessarily to scale. Features shown numbered in certain figures which may appear un-numbered in other figures are the same features unless noted otherwise herein.

### DETAILED DESCRIPTION OF THE INVENTION

The following description of the preferred embodiment(s) is merely exemplary in nature and is in no way intended to limit the invention, its application, or uses. The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

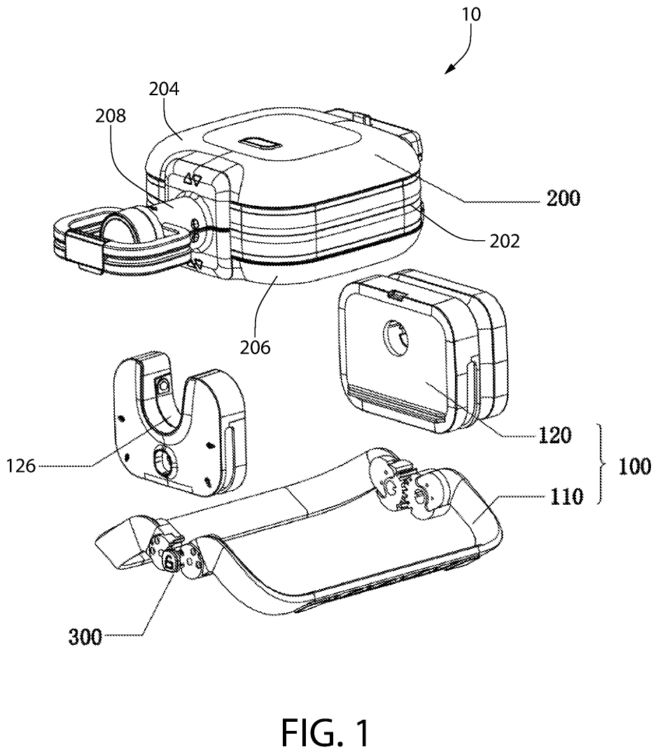

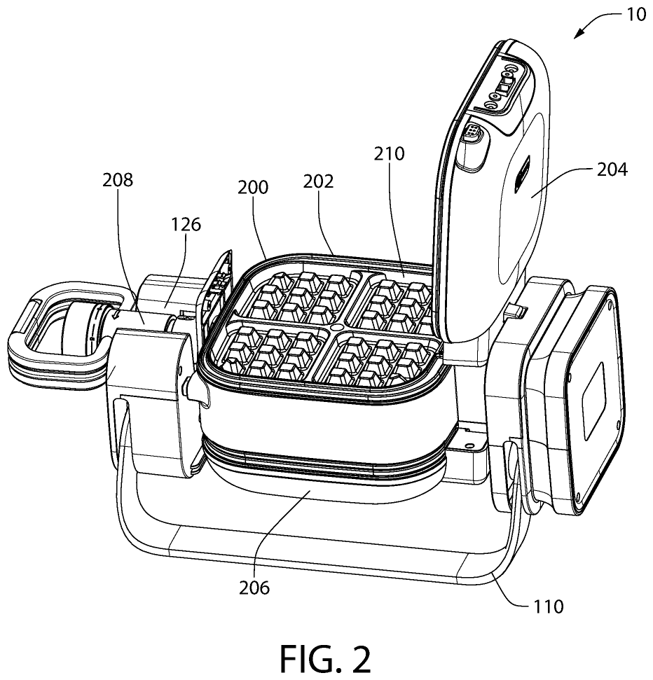

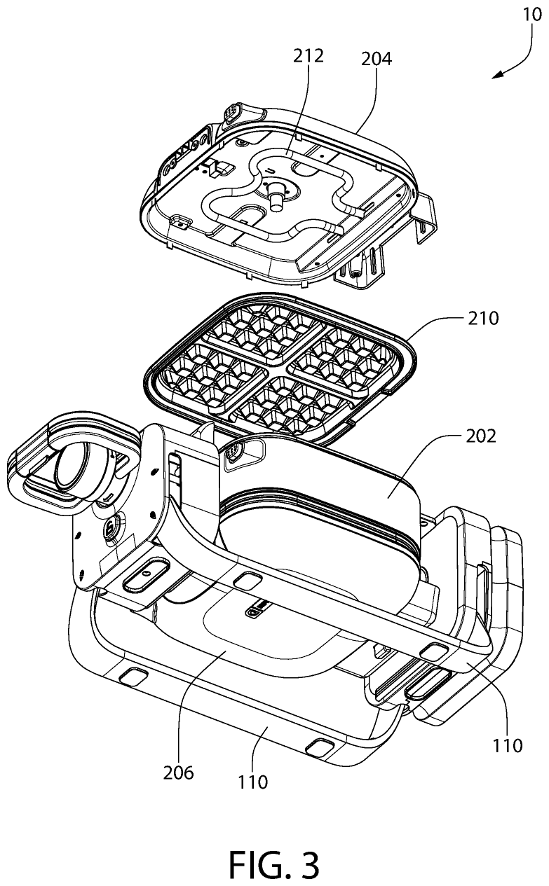

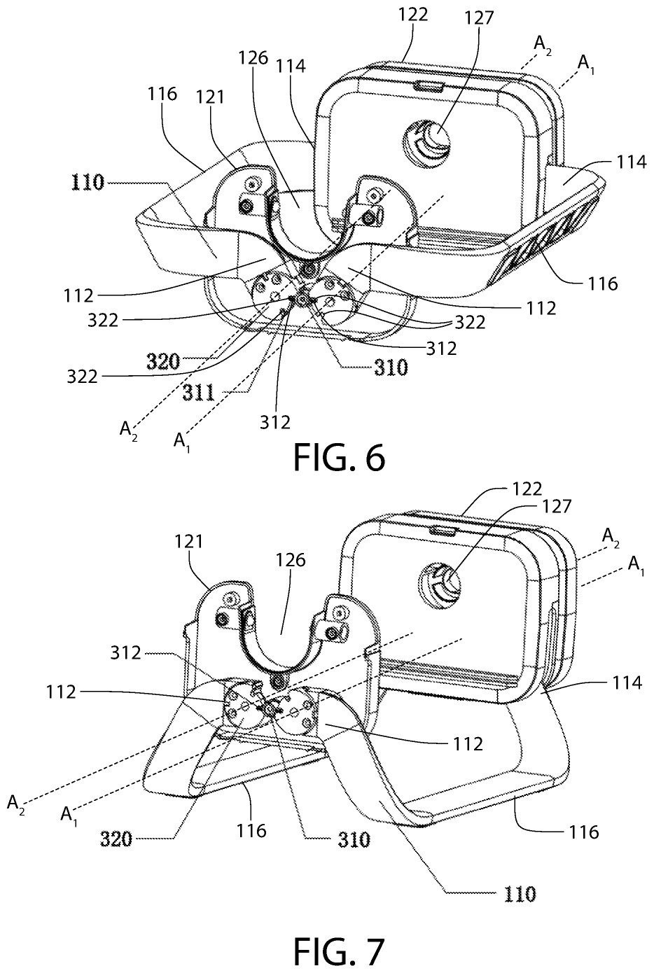

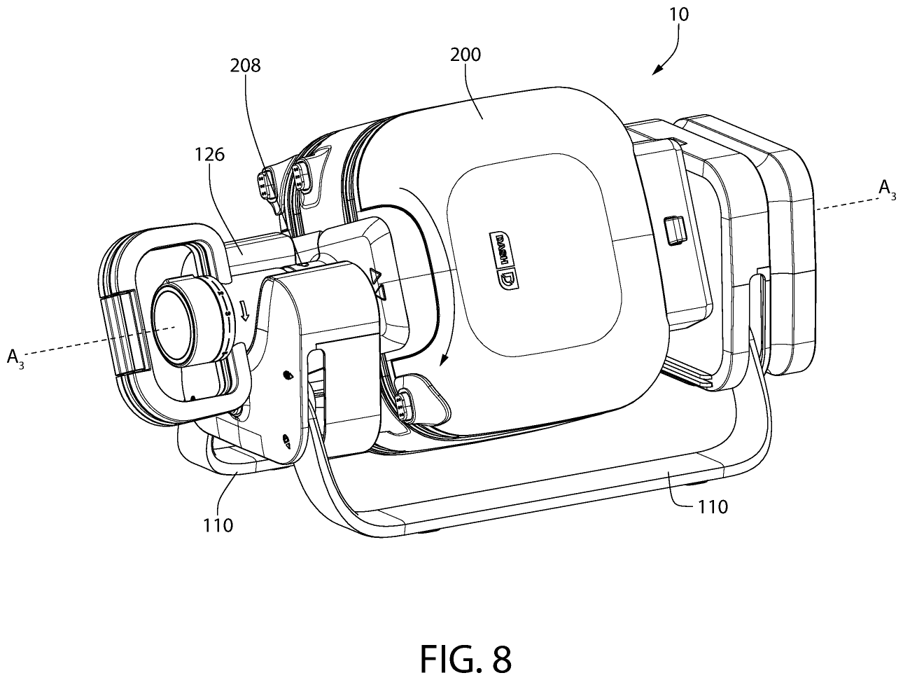

As shown in FIGS. 1 to 12, the present embodiment discloses a double layer cooking appliance with a stowable base. In particular, the cooking appliance is able to cook food items on two separate cooking surfaces, each of which may be selectively exposed by rotating a main body with respect to a base. Referring to FIGS. 1-3, the cooking appliance 10 includes a base 100 and a main body 200 mounted on the base 100. The main body 200 is rotatably connected to the base 100. The base 100 includes at least two support legs 110 which are configured to rotate in opposite directions as will be discussed in greater detail below. The support legs 110 are connected by a locking mechanism 300, so that the base 100 has an unfolded state and a stored state. The base 100 may be transitioned from the unfolded state where the support legs 110 are positioned under the main body 200 of the cooking appliance 10 to the stored state where the support legs are positioned on opposite sides of the main body 200. The operation of the base will be discussed in greater detail below.

The main body 200 has a central portion 202 and first and second cover portions 204, 206. The first and second cover portions 204, 206 enclose cooking surfaces 210 and heating elements 212, allowing cooking on opposing sides of the central portion 202. Optionally, both the central portion 202 and the first and second cover portions 204, 206 may be provided with cooking surfaces to enable cooking a food item on both sides concurrently. Each cooking surface may be provided with a heating element or two cooking surfaces may share a single heating element. In some implementations, the cooking appliance 10 may be a waffle maker, pancake maker, panini press, or other griddle type appliance.

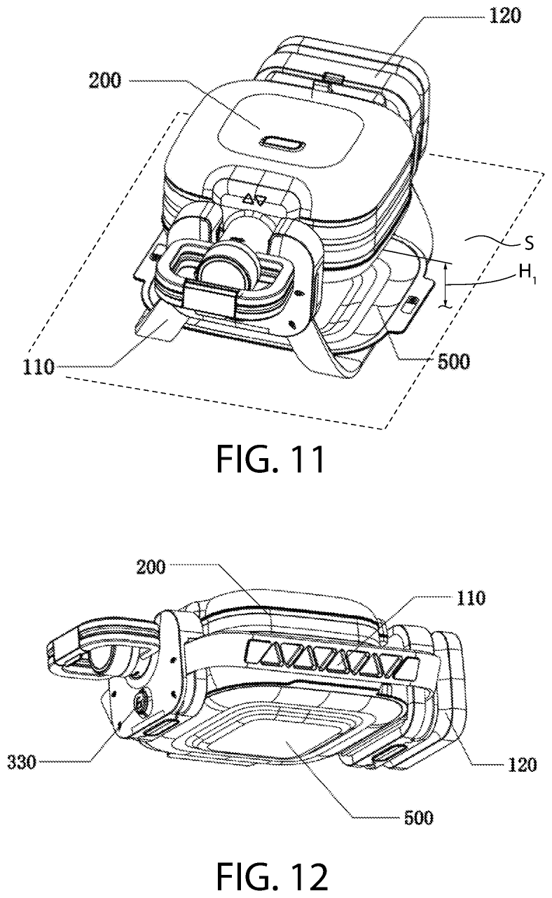

Turning to FIGS. 10 and 11, the cooking appliance 10 is illustrated in the unfolded and stored states. FIG. 10 illustrates the stored state, while FIG. 11 illustrates the unfolded state. In the unfolded state, the support legs 110 are positioned under the main body 200 of the cooking appliance 10 so that the main body 200 of the cooking appliance is positioned at a first height H₁ with respect to a support surface S. In the stored state, the support legs 110 are positioned on both sides of the main body 200, so that the main body 200 is positioned at a second height H₂ with respect to the support surface S. The first height H₁ is greater than the second height H₂. In some implementations, the second height H₂ may be zero because the main body 200 rests on the support surface S. Preferably, the heights H₁, H₂ are measured from the bottom of the main body 200 to the support surface S.

As can be seen, the main body 200 is incapable of being rotated with respect to the base 100 while the base 100 is in the stored state because the main body 200 contacts the support surface S. While it may be possible to pick up the cooking appliance 10 and rotate the main body 200 with respect to the base 100, it is not possible to rotate the main body 200 while the cooking appliance 10 rests on the support surface S. However, when in the unfolded state, the main body 200 is raised by the support legs 110 of the base 100, providing adequate space for the main body 200 to rotate without interference from the base 100 or the support surface S.

The unfolded state allows the main body 200 to be positioned in a first orientation with respect to the base 100 and a second orientation with respect to the base 100, the first orientation being opposite the second orientation. In the first orientation, the first cover portion 204 is up, with the second cover portion 206 facing toward the support surface S. In the second orientation, the second cover portion 206 is up, with the first cover portion 204 facing toward the support surface S.

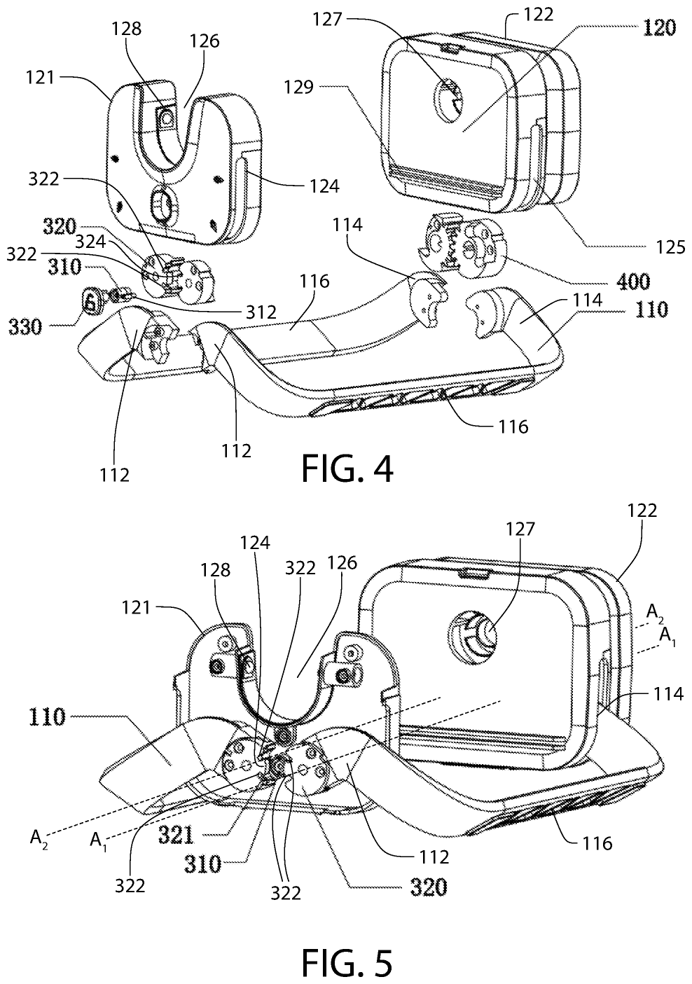

Turning to FIGS. 4-8, the locking mechanism 300 is illustrated in greater detail. The locking mechanism 300 may be operated to fix the base 100 in the unfolded state or the storage state, preventing the support legs 110 from moving when in either the unfolded state or the storage state. The locking mechanism 300 has a locking piece 310, an actuator 330, and first and second locking blocks 320. The locking blocks 320 are configured to rotate about first and second axes A₁-A₁, A₂-A₂. The locking blocks 320 are coupled to the first and second supporting legs 110, so that the first and second supporting legs 110 rotate about the first and second axes A₁-A₁, A₂-A₂.

The locking blocks 320 each have first and second locking grooves 322 and an unlocking groove 324 extending between the first and second locking grooves 322. The locking piece 310 includes two locking ribs 312 which engage the locking grooves 322 of the locking blocks 320. The locking piece 310 may be biased into engagement with the locking grooves 322 using a spring or other biasing element. The locking piece 310 prevents rotation of the first and second supporting legs 110 about the first and second axes A₁-A₁, A₂-A₂ when the locking ribs 312 are engaged with one of the locking grooves 322.

In order to transition from the unfolded state to the storage state, the user applies pressure to the actuator 330, causing the ribs 312 to disengage from the locking grooves 322. The supporting legs 110 are then rotated about the first and second axes A₁-A₁, A₂-A₂ to transition from the unfolded state to the storage state or vice versa. In between the unfolded state and the storage state, the locking ribs 312 engage the unlocking grooves 324. The unlocking grooves 324 maintain the locking ribs 312 out of engagement, allowing the locking ribs 312 to slide along the unlocking grooves 324. When the end of the unlocking grooves 324 are reached, the locking ribs 312 are locked into engagement with the locking grooves 322.

The two supporting legs 110 can be rotated between the unfolded state and the storage state, rotating about the first and second axes A₁-A₁, A₂-A₂. The supporting legs 110 are arranged in a generally U shape, extending from a first end 112 to a second end 114, a supporting foot 116 formed at the base of the U between the first and second ends 112, 114. In the unfolded state, the supporting feet 116 rest against the supporting surface S. In the storage state, the supporting feet 116 are spaced and isolated from the supporting surface S.

In some embodiments, in the present embodiment, two locking grooves 322 are provided, and are used for locking the supporting legs 110 in the storage state and locking in the unfolded state, respectively. In other embodiments, a plurality of locking grooves 322 may be provided to adjust the unfolding angle of the supporting legs 110 in the unfolded state or the storage position in the storage state.

In some embodiments, the locking blocks 320 may be circular blocks, and can rotate along with the supporting leg 110. The locking blocks 320 are preferably fixed to the first ends 112 of the supporting legs 110. More than two locking grooves 322 may be utilized to allow positioning in more than just the unfolded state and the storage state as desired.

In some embodiments, the actuator 330 is further provided on the base 100, the actuator 330 configured to actuate the locking member 310. The actuator 330 extends outside of a protective case 120 which encloses the locking mechanism 300. When the locking mechanism 300 is operated, the locking piece 310 can be retracted into the unlocking groove 324 only by pressing the actuator 330 so that the locking mechanism 300 is unlocked. Releasing the actuator 330 allows the locking member to re-engage the locking grooves 322.

By simultaneously pressing the actuator 330 and rotating the supporting legs 110 slightly, the locking piece 310 is retained within the unlocking groove 324. Further rotation of the supporting legs 110 ejects the locking piece 310 out of the unlocking groove 324, causing the locking piece 310 to engage the locking grooves 322 and lock the locking mechanism 300. In some embodiments, the biasing element used to bias the locking piece 310 is a spring.

The protective case 120 is formed in first and second parts 121, 122. The first part 121 covers the first ends 112 of the supporting legs 110, the locking blocks 320, and the locking piece 310. The first part 121 further incorporates slots 124 which allow the supporting legs 110 to extend out of the first part 121 and move from the unfolded state to the storage state. The second part 122 encloses the second ends 114 of the supporting legs 110 and a transmission piece 400. The second part 122 has slots 125 which allow the supporting legs 110 to extend through the second part and permit movement of the supporting legs 110.

The protective case 120 is arranged on opposite sides of the main body 200, with the first part 121 having a slot 126 and the second part 122 having an aperture 127. The slot 127 and the aperture 127 receive a shaft 208 which extends from opposite sides of the main body 200 to allow rotation of the main body 200 about the shaft 208. The shaft 208 extends along an axis A₃-A₃, and the main body 200 may rotate about the axis A₃-A₃. Optionally, the first part 121 of the protective case 120 may incorporate detents 128 which cause the main body 200 to stop at specific orientations, ensuring that the main body 200 is not subject to accidental rotation and stops such that the cooking surfaces are oriented in a desirable position. Subsequently, whichever one of the first and second cover portions 204, 206 that is facing upward may be opened, with the selected cover portion 204, 206 passing out of the slot 126, pivoting about a hinge and exposing the cooking surface.

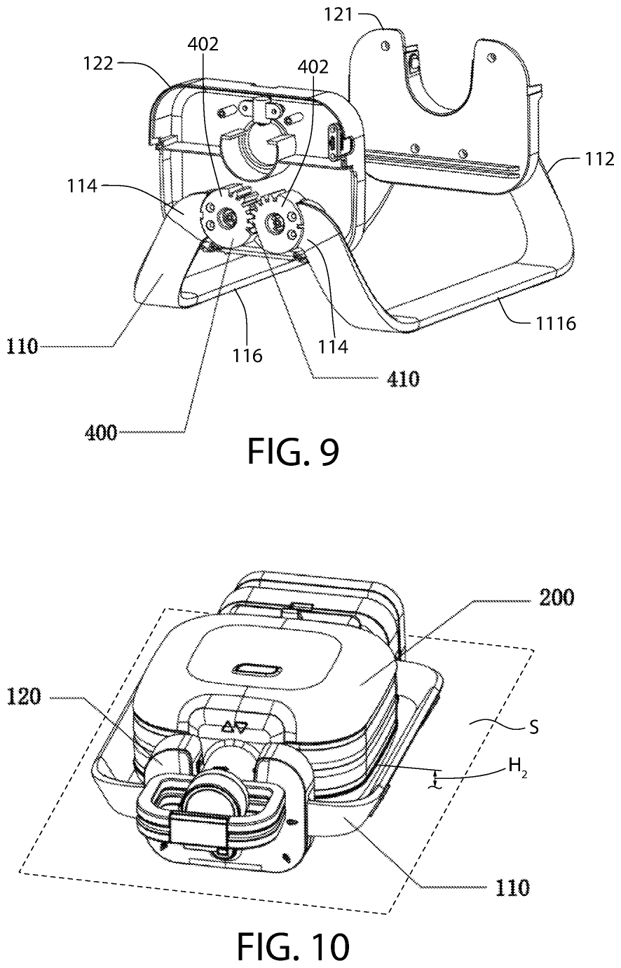

Referring to FIG. 9, the supporting leg 110 is further provided with a transmission piece 400. The transmission piece 400 has first and second transmission parts 402. A circumferential surface of each of the first and second transmission parts 402 is provided with transmission teeth 410; the transmission pieces 402 rigidly coupled to the second ends 114 of the support feet 110. The transmission teeth 410 rotationally couple the support feet 110 so that they are rotate an equal rotational distance, ensuring that the support feet 110 are both either in the unlocked state or the storage state. Thus, the support feet 110 are rotationally coupled via the transmission piece 400.

In some embodiments, the transmission parts 402 are circular, the transmission teeth 410 disposed on the peripheral surface of the transmission member 400. Preferably, the number of the transmission parts 402 is identical to that of the supporting legs 110, and the transmission parts 402 on the two supporting legs 110 are engaged by the transmission teeth 410. In the process of rotating the supporting legs 110, the transmission parts 402 are meshed and transmit rotation through the transmission teeth 410, so that the two supporting legs 110 simultaneously rotate by the same angle. This beneficially ensures that the base 100 provides support to the cooking appliance 10, providing stability and preventing accidental tipping of the cooking appliance 10.

In order to increase the versatility of the cooking appliance, the inner end surface of the protective case 120 is provided with a holding groove 129 for placing a food tray 500. In use, the food tray 500 may be removed from the holding groove 129 and placed onto the supporting feet 110 for placement of the finished food item. In alternate implementations, the food tray 500 may be used as a drip tray.

Referring to FIG. 12, in the storage state, the food tray 500 is positioned in the holding groove 129, and below the main body 200, the bottom of the food item (i.e., waffle or the like) is flattened and kept stable during storage or transportation. The food tray 500 may nest closely against the main body 200 when the food tray 500 is located within the holding groove 129. When the base 100 is in the storage state, the food tray 500 may rest on the supporting surface S, with the main body 200 slightly spaced from the supporting surface S. In other implementations, the food tray 500 may be removed and the main body 200 may rest on the supporting surface S. When in the storage state, the food tray 500 may be removed by sliding the food tray 500 out of the holding groove 129. Thus, the holding groove 129 is located below the supporting legs 110 when in the storage state.

While the invention has been described with respect to specific examples including presently preferred modes of carrying out the invention, those skilled in the art will appreciate that there are numerous variations and permutations of the above-described systems and techniques. It is to be understood that other embodiments may be utilized, and structural and functional modifications may be made without departing from the scope of the present invention. Thus, the spirit and scope of the invention should be construed broadly as set forth in the appended claims.

1. A cooking appliance comprising:
a main body comprising a heating element and a cooking surface; and
a base rotatably coupled to the main body, the base comprising:
a locking mechanism; and
first and second supporting legs coupled to the locking mechanism, the first and second supporting legs each comprising a supporting foot;
wherein the base has an unfolded state and a storage state, in the unfolded state the supporting feet of the first and second supporting legs are positioned below the cooking appliance main body, and in the storage state, the first and second supporting legs are positioned on opposite sides of the main body.

2. The cooking appliance of claim 1 wherein in the unfolded state, the supporting feet engage a support surface, and in the storage state the supporting feet are spaced and isolated from the support surface.

3. The cooking appliance of claim 1 wherein in the unfolded state, the supporting feet engage a support surface and the main body is located at a first height above the support surface and in the storage state, the main body engages the support surface, the main body located at a second height above the support surface, the first height greater than the second height.

4. The cooking appliance of claim 1 wherein the first and second supporting legs have a U-shape and extend from a first end to a second end, the first ends of the first and second supporting legs coupled to the locking mechanism.

5. The cooking appliance of claim 4 wherein the supporting feet are located between the first and second ends of the first and second supporting legs.

6. The cooking appliance of claim 4 wherein the second ends of the first and second supporting legs are coupled to a transmission piece, the transmission piece coupling the first and second supporting legs.

7. The cooking appliance of claim 1 wherein the locking mechanism further comprises a locking piece and first and second locking blocks, wherein the first and second locking blocks are fixedly coupled to the first and second supporting legs, the first and second locking blocks configured to rotate along with the first and second supporting legs, wherein first and second locking grooves are formed in the first locking block, the locking piece comprising a locking rib configured to engage one of the first and second locking grooves so that the first and second locking blocks are fixed relative to the locking mechanism.

8. The cooking appliance of claim 7 wherein an unlocking groove extends between the first and second locking grooves of the first locking block, the first locking block free to rotate when the locking rib of the locking piece engages the unlocking groove.

9. The cooking appliance of claim 7 wherein the base further comprises a protective shell covering the first and second locking blocks.

10. The cooking appliance of claim 9 wherein the protective shell comprises a rotating groove, a rotating shaft of the main body extending through the rotating groove.

11. The cooking appliance of claim 1 wherein the base further comprises a transmission piece, the transmission piece comprising first and second transmission parts fixedly coupled to the first and second supporting legs, the first and second transmission parts having transmission teeth to couple rotation of the first leg to rotation of the second leg.

12. A cooking appliance comprising:
a main body comprising a heating element and a cooking surface; and
a base coupled to the main body, the base comprising:
a locking mechanism comprising a locking piece and first and second locking blocks, the first and second locking blocks configured to rotate about first and second axes; and
first and second supporting legs coupled to the first and second locking blocks of the locking mechanism;
wherein the base has an unfolded state and a storage state, the first and second supporting legs rotating about the first and second axes when the base is transitioned from the unfolded state to the storage state.

13. The cooking appliance of claim 12 wherein the base further comprises a transmission piece, the transmission piece comprising first and second transmission parts fixedly coupled to the first and second supporting legs, the first and second transmission parts having teeth to couple rotation of the first leg to rotation of the second leg.

14. The cooking appliance of claim 13 wherein the first and second transmission parts rotate about the first and second axes.

15. The cooking appliance of claim 12 wherein the first and second supporting legs each comprise supporting a supporting foot.

16. The cooking appliance of claim 15 wherein in the unfolded state the supporting feet of the first and second supporting legs are positioned below the cooking appliance main body and in the storage state, the first and second supporting legs are positioned on opposite sides of the main body.

17. The cooking appliance of claim 12 wherein the main body is configured to rotate from a first orientation with respect to the base to a second orientation with respect to the base, the first orientation being opposite the second orientation.

18. A cooking appliance comprising:
a main body comprising a first cooking surface and a second cooking surface; and
a base coupled to the main body, the base comprising:
a locking mechanism; and
first and second supporting legs coupled to the locking mechanism, the first and second supporting legs configured to rotate about first and second axes;
wherein the base has an unfolded state and a storage state, the first and second supporting legs rotating about the first and second axes when the base is transitioned from the unfolded state to the storage state; and
wherein the main body has a first orientation with respect to the base and a second orientation opposite the first orientation.

19. The cooking appliance of claim 18 wherein in the unfolded state, supporting feet of the first and second supporting legs engage a support surface, and in the storage state the supporting feet are spaced and isolated from the support surface.

20. The cooking appliance of claim 18 wherein in the unfolded state, supporting feet of the first and second supporting legs engage a support surface and the main body is located at a first height above the support surface and in the storage state, the main body engages the support surface, the main body located at a second height above the support surface, the first height greater than the second height.
